(19) United States
(12) Patent Application Publication
(10) Pub. No.: US 2022/0222400 A1
(43) Pub. Date: Jul. 14, 2022

(54) SIMULATION APPARATUS, SIMULATION METHOD, AND COMPUTER READABLE MEDIUM STORING PROGRAM

(71) Applicant: SUMITOMO HEAVY INDUSTRIES, LTD., Tokyo (JP)

(72) Inventor: Masato Hirota, Kanagawa (JP)

(21) Appl. No.: 17/526,455

(22) Filed: Nov. 15, 2021

(30) Foreign Application Priority Data
Jan. 13, 2021 (JP) 2021-003775

(51) Int. Cl. G06F 30/25

(52) U.S. Cl. CPC G06F 30/25; G06T 2210/24

(57) ABSTRACT

There is provided a simulation apparatus that analyzes a flow of a fluid using a particle method, the apparatus including: a processing unit that develops a position of each of a plurality of particles in a time domain using the particle method based on a simulation condition. The processing unit divides an analysis space into a plurality of division regions, disposes, in each of the plurality of division regions, the plurality of particles having sizes different from each other for each division region, determines whether or not to add new particles to the division region and determines a portion to which particles are to be added, for each of the plurality of division regions, and adds new particles to a portion determined as the portion to which particles are to be added in a case where new particles are to be added.

### RELATED APPLICATIONS

The content of Japanese Patent Application No. 2021-003775, on the basis of which priority benefits are claimed in an accompanying application data sheet, is in its entirety incorporated herein by reference.

### BACKGROUND

### Technical Field

Certain embodiment (s) of the present invention relate (s) to a simulation apparatus, a simulation method, and a computer readable medium storing a program.

### Description of Related Art

A simulation method of analyzing a movement of a fluid by approximating the movement of the fluid as a movement of a particle system is known. The simulation method is called a particle method. In the particle method, a fluid is represented by a plurality of particles, and a wall boundary disposed in a flow field of the fluid is also generally represented by a plurality of particles.

### SUMMARY

In fluid analysis by the particle method, a spatial resolution is determined according to diameters of the particles. The diameters of the particles should be set to be sufficiently small with respect to a length scale of the fluid movement to be analyzed. In general, the length scale of the fluid movement varies depending on a portion. For example, in a region apart from a wall of an object disposed in a fluid, even in a case where the diameters of the particles are set to be large, analysis can be performed with sufficiently high accuracy. On the other hand, in the vicinity of the wa1ll, the length scale of the fluid movement is represented by a thickness of a boundary layer . Thus, in order to accurately analyze the movement of the fluid in the vicinity of the wall, the diameters of the particles should be set to be smaller than a thickness of the boundary layer.

In order to perform analysis for the entire analysis space with a high precision, even in a region apart from the wall, the diameters of the particles should be set to be small according to the thickness of the boundary layer . For this reason, the number of the particles disposed in the analysis space increases, and as a result, an amount of calculation increases.

There is a need for providing a simulation apparatus, a simulation method, and a computer readable medium storing a program capable of maintaining high analysis accuracy and reducing an amount of calculation in analysis using the particle method.

According to an embodiment of the present invention, there is provided a simulation apparatus that analyzes a flow of a fluid using a particle method, the apparatus including: an input unit to which a simulation condition is input; and a processing unit that develops a position of each of a plurality of particles in a time domain using the particle method based on the simulation condition which is input to the input unit, in which the processing unit divides an analysis space into a plurality of division regions, disposes, in each of the plurality of division regions, the plurality of particles having sizes different from each other for each division region, determines whether or not to add new particles to the division region and determines a portion to which particles are to be added, for each of the plurality of division regions, based on a current number of the particles in the division region and a degree of density of the particles at a boundary surface between the division regions, in a case where a position of each of the plurality of particles is developed in a time domain for each of the plurality of division regions, and adds new particles to a portion determined as the portion to which particles are to be added in a case where new particles are to be added.

According to another embodiment of the present invention, there is provided a simulation method of analyzing a flow of a fluid using a particle method, the method including: dividing an analysis space into a plurality of division regions; disposing, in each of the plurality of division regions, a plurality of particles having sizes different from each other for each division region; determining whether or not to add new particles to the division region and determining a portion to which particles are to be added, for each of the plurality of division regions, based on a current number of the particles in the division region and a degree of density of the particles at a boundary surface between the division regions, in a case where a position of each of the plurality of particles is developed in a time domain for each of the plurality of division regions; and adding new particles to a portion determined as the portion to which particles are to be added in a case where new particles are to be added.

According to still another embodiment of the present invention, there is provided a computer readable medium storing a program that causes a computer to execute a process, the process including: dividing an analysis space into a plurality of division regions; disposing, in each of the plurality of division regions, a plurality of particles having sizes different from each other for each division region; determining whether or not to add new particles to the division region and determining a portion to which particles are to be added, for each of the plurality of division regions, based on a current number of the particles in the division region and a degree of density of the particles at a boundary surface between the division regions, in a case where a position of each of the plurality of particles is developed in a time domain for each of the plurality of division regions; and adding new particles to a portion determined as the portion to which particles are to be added in a case where new particles are to be added.

By disposing the plurality of particles having sizes different from each other for each division region, it is possible to set a spatial resolution to be different for each division region. By setting sizes of the particles in the division region for which a high spatial resolution is required to be small, analysis can be performed with a required high spatial resolution. By setting sizes of the particles in the division region for which a high spatial resolution is not required to be large, it is possible to reduce the number of the particles. Thereby, an amount of calculation in a simulation can be reduced. By adding new particles to the portion that is determined as a portion to which particles are to be added, it is possible to keep the number of the particles in the division region substantially constant.

### BRIEF DESCRIPTION OF THE DRAWINGS

FIG. 1 is a perspective view illustrating an example of an analysis model to be analyzed by a simulation apparatus according to an embodiment.

FIG. 2 is a schematic diagram illustrating a partial region of an analysis space in a two-dimensional manner.

FIG. 3A is a schematic diagram illustrating portions of two division regions adjacent to each other, and FIG. 3B is a schematic diagram illustrating a case of performing exchange of physical quantities between the two division regions.

FIG. 4 is a schematic diagram illustrating a part of the analysis space in a two-dimensional manner.

FIG. 5 is a lock diagram of the simulation apparatus according to the embodiment.

FIG. 6 is a flowchart illustrating a procedure of a simulation method according to the embodiment.

FIG. 7 is a perspective view of the analysis model.

FIG. 8A is a schematic diagram illustrating a boundary S that is a basis for dividing the analysis space into a plurality of division regions, and FIG. 8B is a sectional view parallel to an xy plane passing through a center of a sphere in the analysis space in a case where the Reynolds number Re is 200.

FIG. 9 is a graph illustrating calculation results of a drag coefficient acting on the sphere in the analysis space together with experimental values.

### DETAILED DESCRIPTION

Before explaining one embodiment of the present invention, a general particle method will be briefly described. The particle method includes an SPH method, a dissipative particle method, an MPS method, and the like. A fluid having a volume V and a density ρ₀ is represented as a set of N particles 20. A density ρᵢ of an i-th particle is represented by the following equation using a distribution function w.

$${ρ}_{1} = {\sum }_{j} w ( {r}_{ij} ) {m}_{j} \qquad ( 1 )$$

The distribution function w (rᵢⱼ) is called a kernel function, and is rotationally symmetric around the origin. rᵢⱼ indicates a distance between centers of an i-th particle and a j-th particle,5 and mⱼ indicates a mass of the j-th particle. As the distribution function w(r), for example, the following function can be used.

$$w ( r ) = \frac{1}{4 π {h}^{3}} [ {( 2 - r )}^{3} - 4 {( 1 - r )}^{3} ] ( 0 \leq r < h ) \\ w ( r ) = \frac{1}{4 π {h}^{3}} {( 2 - r )}^{3} ( h \leq r < 2 h ) \\ w ( r ) = 0 ( r \geq 2 h ) \qquad ( 2 )$$

Here, h indicates a kernel width, and can be set to, for example, a value similar to an average particle distance in an initial state. The kernel width h can be considered as a diameter of the particle.

The following movement equation z is applied as a governing equation of a particle system.

mᵢ\dot{v}ᵢ=Fᵢ^{vis}+mᵢg (3).

Here, mᵢ indicates a mass of the i-th particle, vᵢ indicates a velocity of the i-th particle, vᵢdot indicates an acceleration of the i-th particle, Fᵢ^{prs} indicates a pressure gradient force between the particles, Fᵢ^{vis} indicates a viscous force between he particles, and g indicates a gravitational acceleration.

The pressure gradient force FᵢP^{rs} can be represented by the following equation.

$${F}_{i}^{prs} = {\sum }_{j} \{ - {m}_{i} {m}_{j} ( \frac{{P}_{1}}{{ρ}_{i}^{2}} + \frac{{P}_{j}}{{ρ}_{j}^{2}} ) ∇ w ( {r}_{ij} ) \frac{{r}_{ij}}{\vert {r}_{ij} \vert} \} \qquad ( 4 )$$

Here, Pᵢ indicates a pressure of the i-th particle, Pⱼ indicates a pressure of the j -th particle, and Pi can be represented by the following equation.

Pᵢ=k₀(ρ_{f}−ρ_{of}) (5)

Here, k₀ indicates a gas constant, pᵢ indicates a density of the i-th particle represented by Equation (1) , and ρ₀ᵢ indicates a reference density of the i-th particle.

The viscous force Fᵢ^{vis} can be represented by the following equation.

$${F}_{j}^{vls} = {\sum }_{j} μ {m}_{i} {m}_{j} \frac{∇ w ( {r}_{ij} )}{\vert {r}_{ij} \vert} \cdot \frac{{v}_{j} - {v}_{i}}{{ρ}_{i} {ρ}_{j}} \qquad ( 6 )$$

Here, μ indicates a viscosity of the fluid.

By numerically solving the movement equation as Equation (3) , the velocity v of the particle is developed in a time domain. Further, a position of the particle is developed in a time domain based on the velocity v of the particle. Every time the position of the particle changes, the density of the particle is calculated using Equation (1).

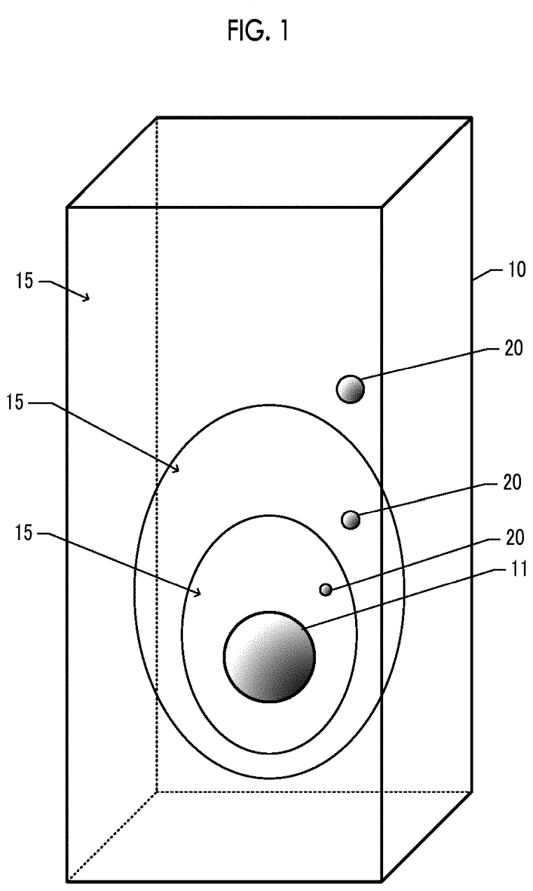

Next, a simulation apparatus and a simulation method according to an embodiment of the present invention will be described with reference to FIG. 1 to FIG. 9.

FIG. 1 is a perspective view illustrating an example of an analysis model to be analyzed by the simulation apparatus according to the embodiment. The analysis model includes an analysis space 10 and a spherical space 10 disposed in the analysis space 10. The analysis space 10 is divided into a plurality of regions (hereinafter, referred to as division regions 15). In the example illustrated in FIG. 1, the analysis space 10 is divided into three division regions 15. An innermost first division region 15 includes the spherical wall 11, and a second division region 15 includes the first division region. A region outside the second division region 15 in the analysis space 10 corresponds to a third division region 15.

A plurality of particles 20 are disposed in each of the division regions 15. Note that FIG. 1 illustrates only one particle 20 for each of the division regions 15. Further, the particle 20 is represented as being larger than the particle disposed in an actual simulation. A diameter of the particle 20 is different for each of the division regions 15. For example, the particle 20 in the innermost first division region 15 has a smallest size, and the particle 20 in the outermost third division region 15 has a largest size. A plurality of particles 20 in one division region 15 have the same size. The size of the particle 20 is determined according to a spatial resolution required to analyze movement of the fluid in each division region 15.

In the embodiment, the following three technical elements are required as compared with a particle method in the related art.

A first technical element is a technique for dividing the analysis space 10 into a plurality of division regions 15 having a certain shape. A second technical element is a technique for exchanging physical quantities of the particles 20 between two adjacent division regions 15 among the plurality of division regions 15. A third technical element is a technique for controlling the particles 20 that flow into each of the plurality of division regions 15 and the particles 20 that flow from each of the plurality of division regions 15. Hereinafter, these techniques will be described.

Technique for Dividing Analysis Space into Plurality of Division Regions

First, the technique for dividing the analysis space into the plurality of division regions 15 will be described.

For example, a signed distance function (SDF) is used as a method for dividing the analysis space 10 (FIG. 1) into the plurality of division regions 15 having a certain shape. The signed distance function φ is a continuous function which is defined for the entire analysis space 10, and has, as a function value, a shortest distance from a given certain boundary S to a certain position x. Further, the signed distance function φ has a negative sign inside the boundary S, and has a positive sign outside the boundary S.

In order to calculate a value of the signed distance function φ, as an initial condition, φ=0 on the boundary S is given, and the following advection equation may be solved.

$$\frac{\partial ϕ}{\partial t} + v \cdot ∇ ϕ = θ \qquad ( 7 )$$

Here, t indicates time, and v indicates an artificial advection velocity.

The position and the shape of the boundary S for dividing the analysis space 10 are determined, and the signed distance function φ is calculated using the boundary S. The analysis space 10 is divided into the plurality of division regions 15 by at least one equivalent surface on which values of the signed distance function φ are equal. The equivalent surface is a boundary surface between two division regions 15 that are in contact with each other. As a shape of the boundary S, for example, a shape based on a shape of the space 10 disposed in the analysis space 10 may be adopted.

The shape of the boundary S can be arbitrarily determined by a user using CAD data or the like. Thus, the analysis space 10 can be divided into the plurality of division regions 15 having a certain shape.

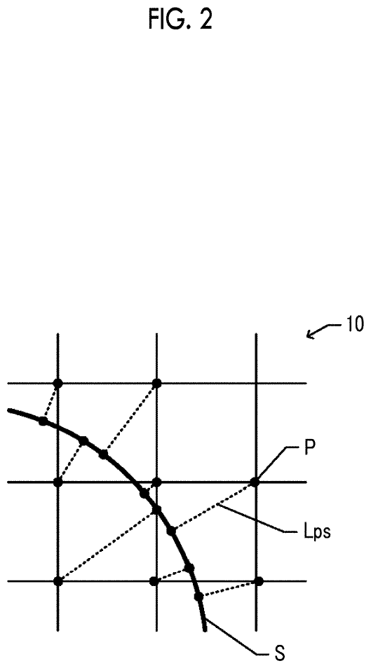

Next, a specific example of obtaining values of the signed distance function φ at a plurality of discretized grid points in the analysis space 10 will be described with reference to FIG. 2.

FIG. 2 is a schematic diagram illustrating a partial region of the analysis space 10 in a two-dimensional manner. A boundary S is set in the analysis space 10. Further, an orthogonal equidistance grid is set in the analysis space 10. For each of the plurality of grid points P in the vicinity of the boundary S, an exact value of a distance Lps from the grid point P to the boundary S is calculated. The value corresponds to the value of the signed distance function φ at a position of the grid point P. For the grid point P inside the boundary S, a negative value is given as the distance Lps. For the grid point P other than the grid points Pin the vicinity of the boundary S, an appropriate value which is larger than the distance Lps from the grid point P in the vicinity of the boundary S to the boundary S is set as an initial value. At this time, a negative value is set for the grid point P inside the boundary S, and a positive value is set for the grid point P outside the boundary S.

By performing discretization of Equation (7) , the value of the signed distance function φ is developed in a time domain. In a case where the values of the signed distance function φ at all the grid points Pare converged, the calculation is ended. The convergence value corresponds to the value of the signed distance function φ at each grid point P. In this way, the value of the signed distance function φ at the position of each of the plurality of grid points P defined in the analysis space 10 can be determined. A surface including the plurality of grid points P having substantially the same value of the signed distance function φ is adopted as the boundary of the division region 15.

Technique for Exchanging Physical Quantities between Two Adjacent Division Regions

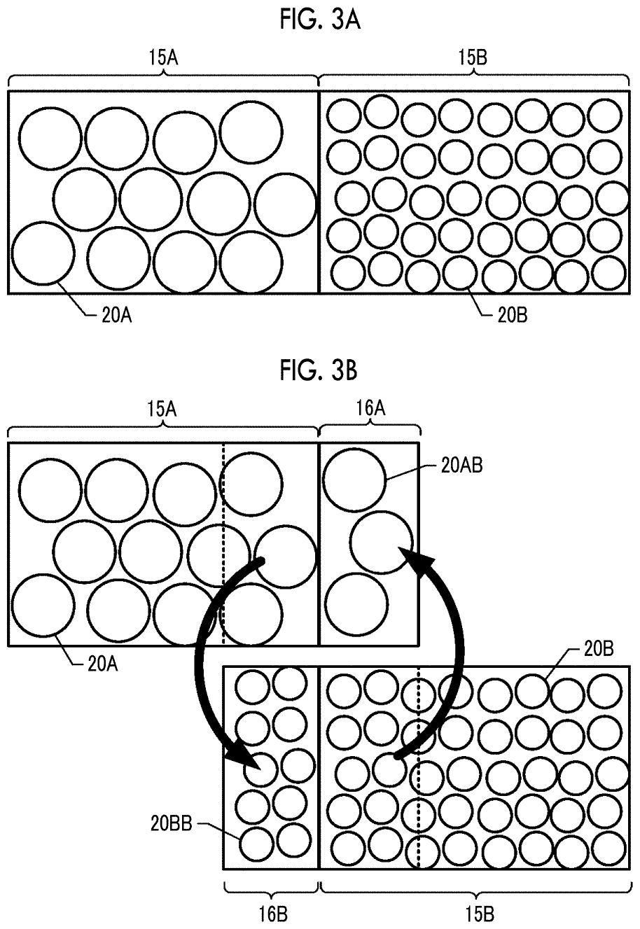

Next, a technique for exchanging physical quantities between two adjacent division regions 15 will be described with reference to FIG. 3A and FIG. 3B.

FIG. 3A is a schematic diagram illustrating portions of two division regions 15A and 15B adjacent to each other. A plurality of particles 20A are disposed in one division region 15A, and a plurality of particles 20B are disposed in the other division region 15B. The particles 20A in one division region 15A are larger than the particles 20B in the other division region 15B.

FIG. 3B is a schematic diagram illustrating a case of performing exchange of physical quantities between the two division regions 15Aand 15B . At a boundary surface between the two division regions 15A and 15B, buffer regions 16A and 16B are defined. The buffer region 16A is a region obtained by extending one division region 15A toward the inside of the other division region 15B, and the buffer region 16B is a region obtained by extending one division region 15B toward the inside of the other division region 15A. The buffer region 16A obtained by extending the division region 15A is overlapped with a portion of the division region 15B. Similarly, the buffer region 16B obtained by extending the division region 15B is overlapped with a portion of the division region 15A.

As an example, thicknesses of the buffer regions 16A and 16B are approximately four times the particle diameter h of the particle 20A having a larger size. The particle diameter h is the same as the kernel width h which is used in the definition of the kernel function w(r) of Equation (2).

In the buffer region 16A obtained by extending the division region 15A, a plurality of particles 20AB having the same size as the particles 20A in the division region 15A as an extension source are disposed. Similarly, in the buffer region 16B obtained by extending the division region 15B, a plurality of particles 20BB having the same size as the particles 20B in the division region 15B as an extension source are disposed.

The physical quantities of the particle 20AB in the buffer region 16A are calculated by kernel interpolation of the physical quantities of the plurality of particles 20B in the region of the division region 15B that overlaps with the buffer region 16A, instead of being calculated by solving the movement equation of Equation (3). For example, the physical quantities Aᵢ of the i-th particle 20AB in the buffer region 16A are calculated by the following Equation. Specifically, the physical quantities Aᵢ indicate a density and a velocity of the i-th particle 20AB.

$${A}_{i} = {\sum }_{j} \frac{{m}_{j}}{{ρ}_{j}} {A}_{j} {W}_{A} ( {r}_{ij} ) \qquad ( 8 )$$

Here, in Equation (8) , the sigma on the right side means summing of the particles 20B in the region of the division region 15B overlapping with the buffer region 16A. mⱼ and ρⱼ indicate a mass and a density of the j-th particle 20B in the division region 15B. Aⱼ indicates physical quantities of the j-th particle 20B in the division region 15B. W_{A} (rᵢⱼ) indicates a kernel function defined for the division region 15A, and rᵢⱼ indicates a distance between the i-th particle 20AB in the buffer region 16A and the j-th particle 20B in the division region 15B.

For the particle 20AB in the buffer region 16A, the movement equation of Equation (3) is not solved. On the other hand, the particle 20AB in the buffer region 16A is treated as a particle that affects the particle 20A when solving the movement equation for the particle 20A in the division region 15A as an extension source.

As in Equation (8) , the physical quantities Aⱼ of the j-th particle 20BB in the buffer region 16B are calculated by the following Equation.

$${A}_{j} = {\sum }_{i} \frac{{m}_{i}}{{ρ}_{i}} {A}_{i} {W}_{A} ( {r}_{ij} ) \qquad ( 9 )$$

Here, in Equation (9) , the sigma on the right side means summing of the particles 20A in the region of the division region 15A overlapping with the buffer region 16B. mᵢ and ρᵢ indicate a mass and a density of the i-th particle 20A in the division region 15A. Aᵢ indicates physical quantities of the i-th particle 20A in the division region 15A. W_{B} (rᵢⱼ) indicates a kernel function defined for the division region 15B, and rᵢⱼindicates a distance between the j-th particle 20BB in the buffer region 16B and the i-th particle 20A in the division region 15A. Technique for Controlling Particles Flowing into Division Region and Particles Flowing from Division Region

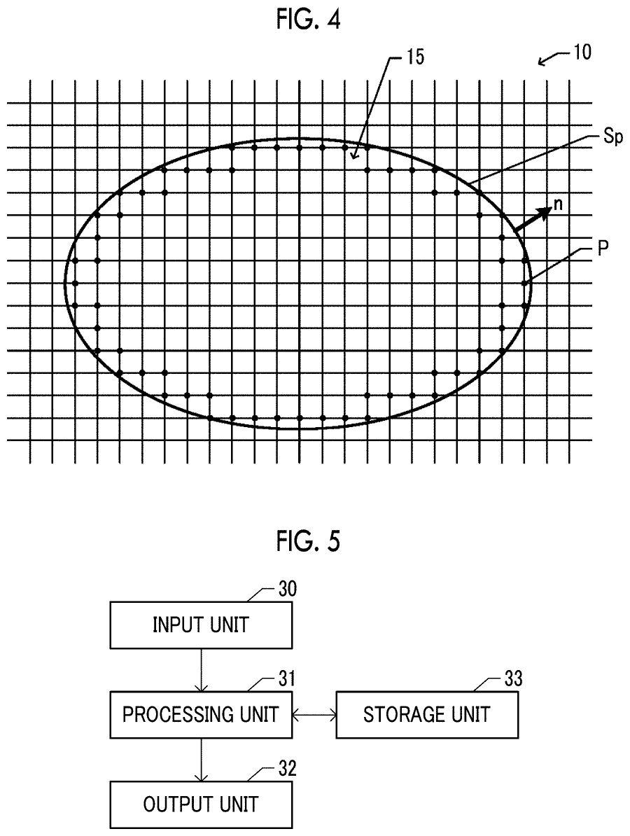

Next, a technique for controlling the particles flowing into the division regions 15 and the particles flowing from the division regions 15 will be described with reference to FIG. 4.

In a simulation by the particle method, since the plurality of particles are moved according to a flow, it is necessary to remove or add the particles in accordance with the particles flowing from the division regions 15 and the particles flowing into the division regions 15. In a case where processing of removing and adding the particles is not consistent with the physical quantities in the flow field, a calculation failure occurs, and analysis accuracy is decreased.

In a case where the analysis space 10 (FIG. 1) is divided into the division regions having a certain shape, a direction and a speed of the flow at the boundary surface between the division regions 15 cannot be determined in advance. Further, in a case where the flow is non-stationary, the direction and the speed of the flow at the boundary surface between the division regions 15 change from moment to moment. For this reason, there is a need for a method of handling the particles flowing into the plurality of division regions 15 having a certain shape and the particles flowing from the plurality of division regions 15 having a certain shape so as to be consistent with the physical quantities in the flow field.

FIG. 4 is a schematic diagram illustrating a part of the analysis space 10 in a two-dimensional manner. The division region 15 surrounded by the boundary surface Sp is defined in the analysis space 10. In the non-compressive flow field in the analysis space 10, the following continuous equation is established.

n·vds=0 (10)

Here, n indicates a normal vector toward the outside of the boundary surface Sp. v indicates a velocity of the fluid. Equation (10) means that a mass of the fluid is maintained in the division region 15.

A square equidistance grid is provided in the analysis space 10, and a plurality of grid points P along the boundary surface Sp are extracted. For example, a grid point which is located in the division region 15 and of which a distance from the boundary surface Sp is equal to or shorter than 2^{1/2}×h is extracted as a grid point P along the boundary surface Sp. Here, h indicates the kernel width shown in Equation (2). In FIG. 4, the extracted grid points P are indicated by black dots. An interval of the square equidistance grid is approximately the same as the kernel width h.

In a case where Equation (10) is discretized using the grid points P disposed along the boundary surface Sp, the following continuous equation is obtained.

$${\sum }_{i} {n}_{i} \cdot {v}_{i} Δ s = 0 \qquad ( 11 )$$

Here, nᵢ indicates a normal vector of the boundary surface Sp at a position of an i-th grid point P, and vᵢ indicates the velocity of the fluid. The sigma symbol on the right side means summing of all grid points P along the boundary surface Sp. As indicates a representative region at each grid point P, and can be defined by, for example, the following equation.

Δs=h² (12)

By checking a sign of each factor on the left side of Equation (11) at a certain time t, a portion at which the fluid is flowing into the division region 15 and a portion at which the fluid is flowing from the division region 15 can be specified. At the grid point P at which an inner product of the normal vector nᵢ and the velocity vᵢ is positive, the fluid flows from the division region 15, and at the grid point P at which the inner product is negative, the fluid flows into the division region 15.

In the simulation to which the particle method is applied, Equation (11) is equivalent to the following equation.

N(t)=const. (13)

Here, N(t) is the number of the particles existing in the division region 15 at a time t. Equation (13) means that the number N(t) of the particles is constant. Equation (13) means that discretized continuous Equation (11) is satisfied by keeping the number of the particles existing in the division region 15 constant.

The number Nᵢₙ (t) of the particles to be added into the division region 15 at a certain time t can be represented by the following equation.

Nᵢₙ(t)=N₀−N(t) (14)

Here, N₀ is the number of the particles existing in the division region 15 in an initial state of the calculation.

In order to determine a portion into which the particles are to be added in a case where the particles in the division region 15 are insufficient, a vacancy rate xᵢ(t) at the position of the i-th grid point P is defined by the following equation.

$${χ}_{i} ( t ) = 1 - {\sum }_{j} \frac{{m}_{j}}{{ρ}_{j}} {W}_{ij} \qquad ( 15 )$$

Here, Wᵢⱼ represents a value of the kernel function given by a distance between the position of the i-th grid point P and the position of the j -th particle . The vacancy rate xᵢ(t) obtained by Equation (15) is 1 in a case where the particles do not exist in the vicinity of the i-th grid point P, and is 0 in a case where the particles are spread in the vicinity of the i-th grid point P. It can be said that the vacancy rate xᵢ(t) represents a degree of density of the particles at the position of the i-th grid point P.

By combining Equation (11) to Equation (15), a differential equation for determining a timing at which the particles flow into the i-th grid point P is defined as follows.

$$\frac{{dF}_{i}}{d t} = \{ \begin{matrix}α \cdot max ( {N}_{0} - N ( t ) , 0 ) \cdot max ( {χ}_{i} ( t ) - {χ}_{i 0} , 0 ) , ( if {n}_{i} \cdot {v}_{i} < 0 ) \\ 0 , ( otherwise )\end{matrix} \qquad ( 16 )$$

Here, α is a certain constant, and can be set to, for example, α=1/N₀. χᵢ₀ is a value of Equation (15) in an initial state at the position of the i-th grid point P. A function Fᵢ is defined for all grid points P along the boundary surface Sp.

For all grid points P, the function Fᵢ in Equation (16) is developed in a time domain in a state where the initial value is set to 0. At a timing at which the value of the function Fᵢ exceeds 1, the particles are added to the position of the i-th grid point P, and the value of the function Fᵢ is initialized to 0. The physical quantities of the particles to be newly added can be obtained by using Equation (8). By determining the timing and the position at which the particles flow by using the differential Equation (16), the continuous Equation (13) can be satisfied for the division region 15 having a certain flow field and a certain shape. The particles flowing from the division region 15 are excluded from the calculation. For example, the particles that flow from the division region 15 and flow into the adjacent division region 15 are excluded from the calculation even in a case of the adjacent division region 15.

Next, a physical meaning of Equation (16) will be described.

Equation (16) means that the function Fᵢ is developed in a time domain based on a current number N(t) of the particles in the division region 15 and the vacancy rate χᵢ(t) at the boundary surface Sp between the division regions 15, that is, the degree of density of the particles. More specifically, for each of a plurality of portions (grid points P) defined on the boundary surface between the division regions 15, based on a difference between the current number N (t) of the particles in the division region 15 and the number N₀ of the particles in the initial state and a difference between the current degree χᵢ(t) of density of the particles at the portion and the degree χᵢ0 of density of the particles in the initial state, whether or not to add the particles to the corresponding portion is determined.

In a case where the current number N(t) of the particles in the division region 15 is larger than the number N₀ of the particles in the initial state, the value of the function Fᵢ does not increase. Further, in a case where the current degree χᵢ(t) of density at the i-th grid point P is higher than the degree χᵢ₀ of density in the initial state, the value of the function Fᵢ at the i-th grid point P does not increase. In other words, when a state where the current number N(t) of the particles in the division region 15 is smaller than the number N₀ of the particles in the initial state continues and a state where the current degree of density is lower than the degree of density in the initial state continues, the particles can be added into the portion at which a sparse state continues.

Further, at the i-th grid point P, it is determined whether the fluid is flowing into the division region 15 as a determination target or flowing from the division region 15 as a determination target. In a case where the fluid is flowing from the division region 15, a value of “otherwise” in Equation (16) is adopted. In other words, new particles are not added to the grid point P at which an outflow of the fluid continues. On the contrary, the grid point P at which an inflow of the fluid continues is listed as a candidate for a portion into which new particles are to be added. That is, based on a determination result of an inflow or an outflow for each grid point P, whether or not to add new particles to the grid point P is determined.

### Simulation Apparatus

FIG. 5 is a block diagram of the simulation apparatus according to the embodiment. The simulation apparatus according to the embodiment includes an input unit 30, a processing unit 31, an output unit 32, and a storage unit 33. A simulation condition or the like is input from the input unit 30 to the processing unit 31. Further, various commands or the like are input from a user to the input unit 30. The input unit 30 includes, for example, a communication device , a removable media reading device, a keyboard, a pointing device, and the like.

The processing unit 31 executes a simulation by the particle method based on the simulation condition and the command which are input. Further, the processing unit 31 outputs a simulation result to the output unit 32. The simulation result includes information representing a state of a particle in a particle system that is a simulation target, a temporal change in physical quantities of the particle system, and the like. The processing unit 31 includes, for example, a central processing unit (CPU) of a computer. A program for causing the computer to execute the simulation by the particle method is stored in the storage unit 33. The output unit 32 includes a communication device, a removable media writing device, a display, and the like.

### Simulation Method

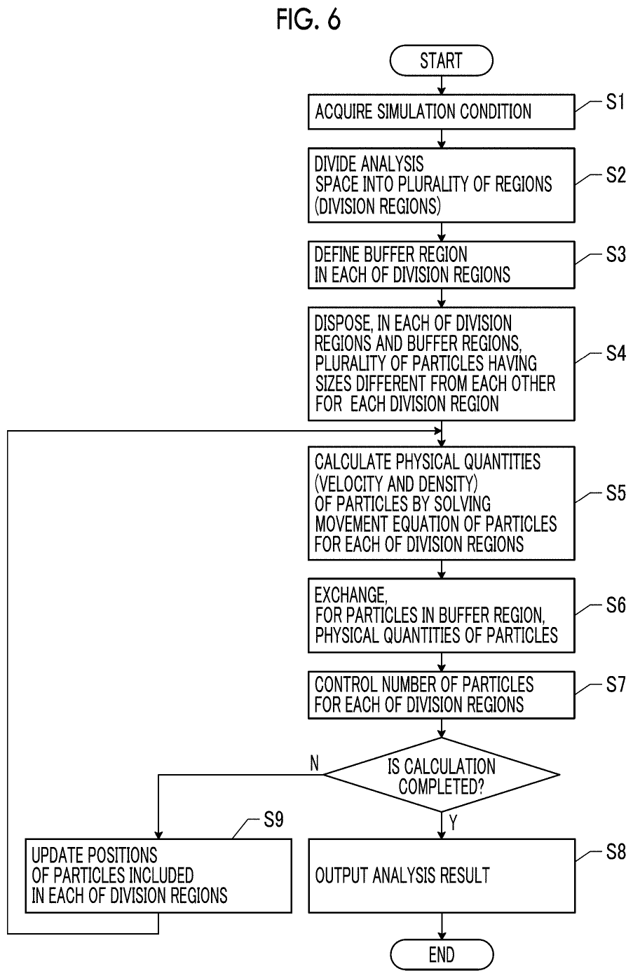

FIG. 6 is a flowchart illustrating a procedure of the simulation method according to the embodiment. Each step illustrated in FIG. 6 is realized by executing the program stored in the storage unit 33 (FIG. 5) by the processing unit 31 (FIG. 5).

First, the processing unit 31 acquires the simulation condition which is input to the input unit 30 (step S1). The simulation condition includes information for defining the fluid as a simulation target, an initial condition, a boundary condition, information for dividing the analysis space 10 into the plurality of division regions 15 (FIG. 1), and the like. In a case where the processing unit 31 acquires the simulation condition, the processing unit 31 divides the analysis space 10 into the plurality of division regions 15 (step S2). For the division of the analysis space 10, for example, as described with reference to FIG. 2, a signed distance function φ is used, and an equivalent surface of the signed distance function φ is set as a boundary surface between the plurality of division regions 15.

The processing unit 31 defines a buffer region in each of the plurality of division regions 15 (step S3). For example, as illustrated in FIG. 3B, the processing unit 31 defines the buffer region 16A by extending one division region 15A of two division regions 15A and 15B that are adjacent to each other toward the inside of the other division region 15B. Similarly, the processing unit 31 defines the buffer region 16B by extending the division region 15B toward the inside of the division region 15A. Next, the plurality of the particles 20 (FIG. 1) having different sizes for each of the division regions 15 are disposed in each of the division regions 15 and the buffer regions 16A and 16B by the processing unit 31. Here, the size of the particle 20 is specified by the kernel width h of Equation (2).

After the particles 20 are disposed, the processing unit 31 calculates the physical quantities of the particles 20, that is, the velocity and the density of the particles 20, by solving the movement equation of the particles 20 for each of the division regions 15 (step S5). The movement equation is represented by Equation (3). Next, for the particles 20AB and 20BB in the buffer regions 16A and 16B (FIG. 3B), the processing unit 31 exchanges the physical quantities of the particles (step S6). The exchange of the physical quantities is performed by the method described with reference to FIG. 3B.

Next, the processing unit 31 controls the number of the particles for each of the division regions (step S7). The number of the particles is controlled by using the method described with reference to FIG. 4. Specifically, the value of the function Fᵢ is obtained by solving the differential Equation (16), and new particles are added to the position of the i-th grid point P at a timing at which the value of the function Fᵢ exceeds 1.

In a case where the calculation for developing the physical quantities of the particles in a time domain is completed, the processing unit 31 outputs an analysis result to the output unit 32 (FIG. 5) (step S8). In a case where the calculation for developing the physical quantities of the particles in a time domain is continued, the processing unit 31 updates the positions of the particles 20 included in each of the division regions 15 (step S9), and repeats the procedure from step S5.

Excellent Effects according to Example

Next, excellent effects according to the embodiment will be described.

In the embodiment, the simulation can be performed by setting spatial resolutions, that is, diameters of the particles 20 to be different from each other for each of the plurality of division regions 15 (FIG. 1). Therefore, by setting the diameters of the particles in the region for which a high spatial resolution is required to be small, the requirement for the spatial resolution can be satisfied. Further, by setting the diameters of the particles in the region for which a high spatial resolution is not required to be large, an amount of calculation can be reduced. In this way, the required spatial resolution can be maintained, and the amount of calculation can be reduced.

Further, in the embodiment, as described with reference to FIG. 2, the boundary S having a certain shape can be determined, and the boundary surface between the plurality of the division regions 15 can be determined using the signed distance function φ. For example, a high spatial resolution is required in the vicinity of a wall surface in a flow field of a fluid or a front surface of an object disposed in a flow field. As described above, preferably, the region for which a high spatial resolution is required is determined according to a shape of the wall surface disposed in the flow field. In the embodiment, by setting the boundary S illustrated in FIG. 2 according to the shape of the wall surface, it is possible to set the division regions having a shape obtained by reflecting the shape of the wall surface. For example, the simulation method according to the embodiment can be applied to analysis of a flow field around an object having a complicated shape or analysis of a flow field in a flow path having a complicated shape.

### Verification of Effects

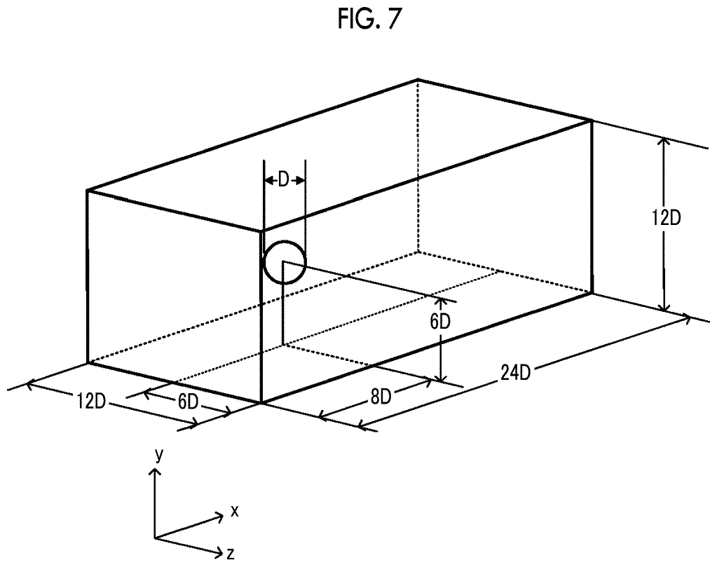

In order to verify the excellent effects according to the embodiment, an actual simulation of a flow field is performed using the simulation method according to the embodiment. Hereinafter, the simulation will be described with reference to FIG. 7 to FIG. 9.

FIG. 7 is a perspective view of the analysis model. The analysis space is a rectangular parallelepiped which is elongated in an x-direction, and a sphere having a diameter D is disposed in the analysis space. In the analysis space, a dimension in the x-direction is 24D, and dimensions in ay-direction and a z-direction are both 12D. The coordinates of the center of the sphere in the analysis space are set to (x, y, z)=(8D, 6D, 6D). The particles are caused to uniformly flow into the analysis space from a front surface facing a negative x axis at an inflow velocity U. A periodic boundary condition is applied for the y-direction and the z-direction in the analysis space. A non-slip condition is applied for a front surface of the sphere.

The Reynolds number Re is defined by the following equation using a kinematic viscosity coefficient v of the fluid.

$$Re = \frac{U \cdot D}{v} \qquad ( 17 )$$

The simulation is performed under three conditions in which the Reynolds number Re is 200, 300, and 500. The minimum diameter h₀ of the particles is set to h₀=10D/Re. Here, h₀ means the kernel width h of Equation (2) . A value of the minimum diameter h₀ is a minimum value required to resolve the flow field in the vicinity of the sphere.

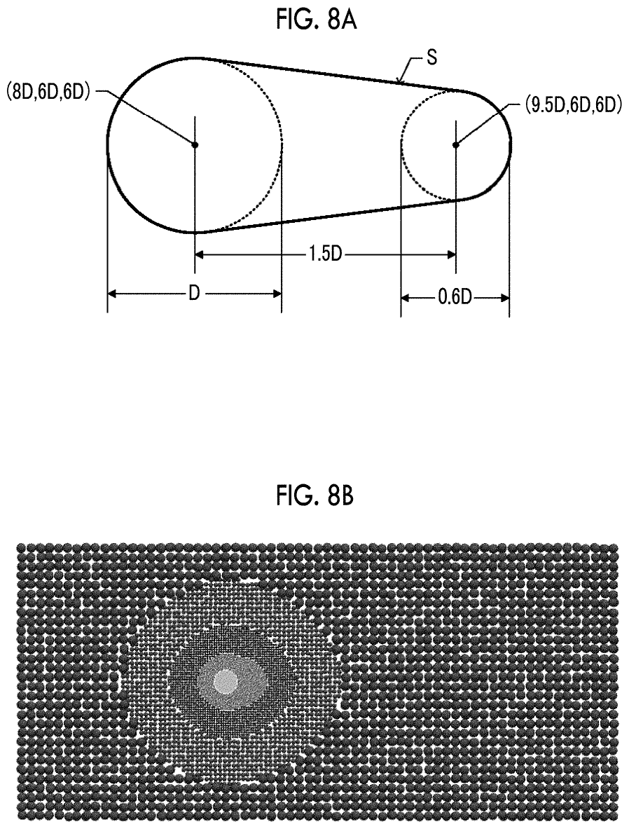

FIG. 8A is a schematic diagram illustrating a boundary S that is a basis for dividing the analysis space into the plurality of division regions. The boundary S corresponds to the boundary S illustrated in FIG. 2. A front surface of a convex hull including a sphere which is located at coordinates (x, y, z)=(8D, 6D, 6D) and has a diameter D and a sphere which is located at coordinates (x, y, z)=(9.5D, 6D, 6D) and has a diameter 0.6D is set as the boundary S. A signed distance function φ of which the value on the boundary S is 0 is defined, and the analysis space is divided into four division regions by three equivalent surfaces on which the values of the signed distance function φ are 0.75D, 2D, and 4D.

FIG. 8B is a sectional view parallel to an xy plane passing through the center of the sphere in the analysis space in a case where the Reynolds number Re is 200. The four division regions are defined so as to surround the sphere in the analysis space by four layers. The diameters of the particles in the division regions are set to h₀, 2h₀, 4h₀, and 8h₀ in order from the division region closer to the sphere. The plurality of the particles are disposed at equal intervals such that a distance between the centers of the particles is equal to the diameter.

A magnitude of the initial velocity of the particles is U, and a direction of the particles is a positive x-axis. The flow field is developed in a time domain during a period for which a dimensionless timing t×D/U changes from 0 to 30. Further, during a period for which the dimensionless timing changes from 15 to 30, a time average value of a drag coefficient that acts on the sphere is calculated.

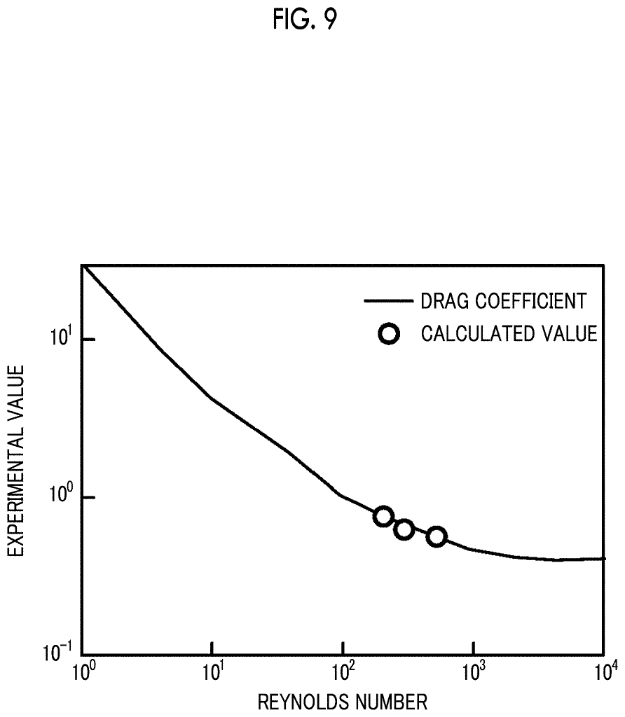

FIG. 9 is a graph illustrating calculation results of the drag coefficient acting on the sphere in the analysis space together with experimental values. A horizontal axis represents the Reynolds number Re, and a vertical axis represents the drag coefficient. A circle symbol in the graph indicates a calculated value of the drag coefficient obtained from the simulation, and a solid line indicates an experimental value of the drag coefficient . As the experimental value of the drag coefficient, a value described in “Japan Society of Mechanical Engineers, Mechanical Engineering Handbook, Basic Edition, A5, Fluid Engineering” is used.

It can be seen that the drag coefficient obtained by the simulation matches with the experimental value. It is confirmed that the flow field can be accurately analyzed by the simulation method according to the embodiment.

In a case where the simulation method according to the embodiment is used, the number of the particles when the Reynolds number Re is 200, 300, and 500 is approximately 390,000, approximately 1.2 million, and approximately 4.7 million. On the other hand, in a method of disposing the particles having a diameter h₀ over the entire analysis space without dividing the analysis space, the number of the particles when the Reynolds number Re is 200, 300, and 500 is approximately 28 million, approximately 96 million, and approximately 432 million. It can be seen that the number of the particles can be significantly reduced by using the simulation method according to the embodiment . Thereby, it is possible to significantly reduce a calculation load.

Further, in the vicinity of the sphere that requires a high spatial resolution, the diameters of the particles are set to h₀. Therefore, analysis of the flow field can be performed with a sufficient spatial resolution.

The above-described example has been presented as an example, and the present invention is not limited to the above-described example. For example, it is obvious to those skilled in the related art that various modifications, improvements, and combinations in the example may be made.

It should be understood that the invention is not limited to the above-described embodiment, but may be modified into various forms on the basis of the spirit of the invention. Additionally, the modifications are included in the scope of the invention.

What is claimed is:

1. A simulation apparatus that analyzes a flow of a fluid using a particle method, the apparatus comprising:
an input unit to which a simulation condition is input; and
a processing unit that develops a position of each of a plurality of particles in a time domain using the particle method based on the simulation condition which is input to the input unit,
wherein the processing unit
divides an analysis space into a plurality of division regions,
disposes, in each of the plurality of division regions, the plurality of particles having sizes different from each other for each division region,
determines whether or not to add new particles to the division region and determines a portion to which particles are to be added, for each of the plurality of division regions, based on a current number of the particles in the division region and a degree of density of the particles at a boundary surface between the division regions, in a case where a position of each of the plurality of particles is developed in a time domain for each of the plurality of division regions, and
adds new particles to a portion determined as the portion to which particles are to be added in a case where new particles are to be added.

2. The simulation apparatus according to claim 1,
wherein, in a case where the processing unit determines whether or not to add new particles to the division region, for each of a plurality of portions defined on a boundary between the division regions as determination targets, the processing unit determines whether or not to add particles to the portion, based on a difference between the current number of the particles in the division region as a determination target and the number of the particles in an initial state and a difference between a degree of density of the particles at the portion and a degree of density of the particles in an initial state.

3. The simulation apparatus according to claim 2,
wherein, in a case where the processing unit determines whether or not to add new particles to the division region, for each of the plurality of portions for determining whether or not to add new particles, the processing unit determines whether the particles are flowing into the division region or flowing from the division region, and determines whether or not to add new particles to the portion based on a determination result of an inflow or an outflow of the particles.

4. The simulation apparatus according to claim 1,
wherein, in a case where a movement of the particles is analyzed for each of the plurality of division regions by using the particle method, in a state where one division region among the plurality of division regions is set as a division region of interest, the processing unit defines a buffer region obtained by extending the division region of interest toward the inside of an adjacent division region, disposes, in the buffer region, the particles having the same size as the particles disposed in the division region of interest, and calculates physical quantities of the particles in the buffer region based on physical quantities of the particles in the adjacent division region including the buffer region.

5. A simulation method of analyzing a flow of a fluid using a particle method, the method comprising:
dividing an analysis space into a plurality of division regions;
disposing, in each of the plurality of division regions, a plurality of particles having sizes different from each other for each division region;
determining whether or not to add new particles to the division region and determining a portion to which particles are to be added, for each of the plurality of division regions, based on a current number of the particles in the division region and a degree of density of the particles at a boundary surface between the division regions, in a case where a position of each of the plurality of particles is developed in a time domain for each of the plurality of division regions; and
adding new particles to a portion determined as the portion to which particles are to be added in a case where new particles are to be added.

6. A computer readable medium storing a program that causes a computer to execute a process comprising:
dividing an analysis space into a plurality of division regions;
disposing, in each of the plurality of division regions, a plurality of particles having sizes different from each other for each division region;
determining whether or not to add new particles to the division region and determining a portion to which particles are to be added, for each of the plurality of division regions, based on a current number of the particles in the division region and a degree of density of the particles at a boundary surface between the division regions, in a case where a position of each of the plurality of particles is developed in a time domain for each of the plurality of division regions; and
adding new particles to a portion determined as the portion to which particles are to be added in a case where new particles are to be added.
